(19) United States
(12) Patent Application Publication
(10) Pub. No.: US 2024/0109176 A1
(43) Pub. Date: Apr. 4, 2024

(54) TOOL WITH EXTENDIBLE HANDLE

(71) Applicant: RTL Materials Ltd., Lymington, Hampshire (GB)

(72) Inventor: Richard Wood, Lymington (GB)

(21) Appl. No.: 18/276,579

(22) PCT Filed: Dec. 31, 2021
(86) PCT No.: PCT/EP2021/087912

§ 371 Date: Aug. 9, 2023

(30) Foreign Application Priority Data
Feb. 9, 2021 (GB) 2101787.6

(51) Int. Cl. B25G 1/04; B25G 1/02; B25G 1/10

(52) U.S. Cl. CPC B25G 1/04; B25G 1/02; B25G 1/10

(57) ABSTRACT

The application describes a tool comprising a tool head and a handle. An end of the handle is connectable to the tool head. The handle comprises a bistable reelable composite member having a first stable form in the form of an elongate slit tube in which form the member is resiliently biased and acts as a handle when connected to the tool head. When separated from the tool head, the tube can be opened out at the slit at an end and progressively coiled around an axis transverse to its length to reversibly attain a second stable form in the form of a coil. Thus, the tool can assume a compact form for storage or transportation.

### CROSS-REFERENCE TO RELATED APPLICATIONS

This application claims the benefit of British Patent Application Serial No. 2101787.6 filed 9 Feb. 2021 and is a national phase entry of International Patent Application Serial No. PCT/EP2021/087912 filed 31 Dec. 2021, both titled Tool with Extendible Handle, each of which is hereby incorporated by reference herein in its entirety.

### TECHNICAL FIELD

The present invention relates to a tool with an extendible handle, and in particular to a tool with interchangeable tool heads, and to associated methods and apparatus.

### BACKGROUND

It is known to deploy tools attached to handles allowing the use to manipulate the tool. Some tools are hand held, having relatively short handles for operation by a single hand. Other tools have longer handles, allowing both hands to manipulate the tool, to create greater leverage or apply greater forces to the tool. The length of the handle is important according to the application—for instance, in a garden implement, such as a rake, where the user may apply leverage, an incorrect length may lead to back ache, etc. The diameter and shape of the handle in cross section may also be important in promoting good grip to allow the tool to be controlled and avoid the tool slipping.

A traditional tool, for instance, may be provided with a wooden handle, being relatively versatile and typically low in cost. Often this is a simple wooden stick, which attaches permanently or semi-permanently to a socket in the tool head, e.g. via a screw friction fit, wedge, etc.

Synthetic materials are also known to provide handles for tools, such as fibreglass, resin and polypropylene. Metal, e.g. aluminium, may also be chosen as a lightweight, durable and suitable material for connecting multi-purpose attachments. Use of such material (telescopic or otherwise) may provide handles with various properties of stiffness, lightness, strength, grip, vibration damping, etc., making them suited for different applications.

However, existing technologies are limited where space for storing the tool is limited. One example, for instance, might be a boat hook, where space on the boat for a lengthy, cumbersome item is limited and where it may prove a hazard. Requiring more than one function from the tool typically requires multiple tools to be obtained, stored and used, each with lengthy handles which makes storage, transportation and deployment problematic.

Some tools, such as mops, are known to be provided with telescopic handles which allow some limited reduction in the overall length of the device when not being used. Some tools have a relatively short handle, allowing it to be used both as a hand tool, e.g. a trowel in a kneeling position, and capable of being fitted to an extension piece of handle to provide a longer handle allowing it to be used when standing.

The profile of the typical existing handle is tapered from one end to the other, so that the tool head can be locked in position by mechanical resistance (i.e. on a hoe) or by the centrifugal force generated by wide swinging actions (i.e. on a pick).

Size, weight and storability are important factors. Robustness and protection against damage are also important considerations, as is minimising the number of moving parts and complexity that might be prone to failure. The tool is preferably weather resistance, can be cleaned and durable. The tool should also be simple to manufacture. The tool should preferably also be simple and quick to stow/unstow. Preferably tools, such as drivers for fasteners, are not needed, as they have the tendency to get lost, etc.

What is needed is versatile, compact, easily stored tools which are lightweight, whilst still being capable of resisting the forces experienced during use of the tool.

The present invention aims to address all or some of these issues and generally provide an improved tool.

### SUMMARY

According to a first aspect of the present invention, there is provided a tool comprising: a tool head; and a handle, wherein an end of the handle is connectable to the tool head, wherein the handle comprises a bistable reelable composite member having a first stable form in the form of an elongate slit tube in which form the member is resiliently biased and acts as a handle when connected to the tool head, and wherein when separated from the tool head, the tube can be opened out at the slit at an end and progressively coiled around an axis transverse to its length to reversibly attain a second stable form in the form of a coil.

The preferred embodiments provide a range of commonly used tools in which the traditional wooden, aluminium or plastic fixed length and telescopic handles are replaced by a bistable handle member which can be detached from the tool head and coiled for storage. “Tool” as used herein refers to any implement used for such purposes as including but not limited to cleaning, grabbing, striking and digging tools, having a handle for a user to manipulate the tool head. Bistability means that the handle is stable both in its elongate form, in which is serves as the handle to the tool, and when coiled, meaning it can be stored without a external housing or other device to constrain the coil and prevent the “explosive” uncoiling of normal materials which store energy as they are coiled. Thus, the tool is capable of being stored in a highly compact package, as well as having a range of interchangeable heads, so that a single handle can be used for a range of different applications. The benefit will be for users who have constrained storage space, and value the ability to reduce the bulk of the product when it is stored when compared to traditional solutions.

This allows the tool to collapse to a much smaller volume for stowing the stand, e.g. in a bag or case, for ease of portability and storage. The handle may be made from fibre reinforced polymer composites, which can be made stiff, light and robust. The member is typically a thin, e.g. between 0.5 mm and 3 mm, shell formed preferably from laminated layers of fibre embedded in a matrix material to aid coiling and bistability. The tool head unit can be made mainly from moulded plastics material and/or metallic alloys, again to provide a lightweight robust stand. This provides a much simpler and lighter mechanism for collapsing the tool that prior art approaches, such as those with telescopic aluminium poles, and which can attain smaller volumes when packed away. The system has a small number of moving parts and is therefore less liable to damage during use.

The handle may in principle be provided in any diameter or length, according to the application and the forces that the tool is required to resist. In most applications, it is anticipated that the tubes will have a diameter of between 2.5 and 5 cm. In most applications, the members will have a length of between 1 meter and 2 meters, e.g. for providing a convenient range of heights for the object for use by a human operator in various positions, etc. and for various applications.

The tool head may have a socket for receiving the end of the bistable composite member. The end of the bistable member may positively lock in the socket. Preferably the lock is such that it prevents the edges of the member moving relative to each other in order to stabilise the member and help prevent twisting of the member, i.e. by holding the member in place in the socket and/or supporting one or more wall of the end of the member to stabilise the edges. For instance, the leading edge of the member may butt up against the bottom of the socket to stabilise the position of that edge and so stabilise the overall form of the member. It is found that a socket that stabilises the end of the member, and particularly prevents movement of the edges relatively to each other, e.g. in a longitudinal direction, is important in helping resist torsional stresses and other loading applied to the handle by the user when using the tool. The socket may be at least as deep as half the diameter of the tube, or more preferably, between one half to one times the diameter of the tube, or in some examples, more than one times the diameter of the tube.

The socket may have walls that support the inner and outer surfaces of the composite member received in the socket and locks the edges of the member to prevent movement relative to each other in order to stabilise the member. Inner and outer surfaces of the socket support the surfaces of the shell like member to help prevent buckling local to the socket, and distribute forces. Preferably, the tool head and socket are a rigid body, e.g. so forces are directly transferred from the handle to the tool head working surface, although in some applications this may not be the case.

In an embodiment, the walls of the socket have engagement features that guide the member into a locking position in the socket. Thus, the features may rotationally align or guide the member into the slot formed by outer and inner walls, for example by a flared opening of the slot to guide the leading edge of the member, and or engaging the longitudinal edges to key their rotational position as they enter the slot.

The slot may be a complete circle in or a part circle in cross section. The gap in a part circle arrangement may key with the slit in the member and may help stabilise the longitudinal edges of the member in the socket. The end of the member may be a press fit in the socket to further help stabilise it, and preferably the leading edge of the member fully enters the socket so as to bear against the bottom of the socket. Thus, the edges of the end of the member and/or the slot are braced against parts of the socket to help stabilise them. The end of the member may need to be compressed slightly (or conversely expanded) before it can be inserted into the socket, such that it bears against the outer socket surface (or inner socket surface) when released as it tries to assume its resilient biased diameter. This can help further stabilise the connection.

In an embodiment, the socket has one or more latches for engaging with a corresponding feature in the end of the bistable composite member to prevent the composite member being removed from the socket. This helps lock the head in place and help the tool resist forces during use that would tend to detach the tool head from the handle. The latch may also help resist resists rotational motion between the tool head and handle. By mechanically locking the handle in the socket, the stability of the end of the member and its connection to the tool head are also strengthened.

In an embodiment, the latch is movable by the user of the tool against a resiliently bias from an engagement position in which it engages with the feature in the end of the bistable composite member to a release position in which the bistable composite member can be released from socket. Preferably the user can operate the latch with a digit of a single hand, such that the user can hold the handle and tool head in either hand to pull them apart/push them together, whilst operating the latch.

The latch may engage with a hole through the end of the member. Thus, a protrusion or pawl of the latch may enter the hole to lock it in position. The protrusion or pawl may have an oblique or camming surface facing the opening of the socket such that, as the end of the member is pushed into the socket, the latch is automatically moved out of the way and no user actuation of the latch is required. Once the end of the member is fully inserted in the socket, the protrusion or pawl is aligned with the hole in the end of the member and can be moved to its locking/engaging position through the hole, either manually or via a biasing force such as provided by a spring. It will be appreciated that other surfaces of the protrusion or pawl are not cammed so that the tool head cannot be pulled away from the handle or twisted on the handle without the user operating the latch.

In an embodiment, the hole and or end of the member is reinforced and/or treated to avoid delamination. This may help prevent delamination as the end of the member is latched into or out of the socket compared with a raw end. For instance, a portion of rubber or fabric sheet may be glued or otherwise attached across the edge of the member or hole to provide greater strength and improve the expected lifespan of the product.

In an embodiment, the tool comprises plural different tool heads which can interchangeably be connected to the tubular member.

In an embodiment, the tool may also comprise a housing, the housing having an outer diameter adapted so that the bistable member can coil around it. In other words, the housing provides a mandrel for the coil to form around, which may help promote coiling, and the stability of the coil and make the assembly less susceptible to damage in the coiled form, e.g. when stored or transported. The housing may also be adapted to couple to one ore more tool heads as well as having the bistable member coiled around it. Thus, the housing additionally provides a “tidy” to secure tool heads when not in use to make it less likely that that the elements of the assembly become separated and or damaged when stored without the need for a bag or case to house them.

The housing may have an internal cavity adapted to the shape of the tool head such that the tool head can be at least partially received and retained in the cavity whilst the bistable member is coiled around the housing such that the tool assumes a compact form. Thus, the space inside the coil may be utilised at least partially to accommodate at least part of a tool head to save space.

In an embodiment, the bistable member has a surface adapted for gripping by a user and/or wear resistance. For example, the surface may be coated with a rubber and/or be textured. Alternatively, the surface finish may be modified through abrasion or by using a peel ply type approach, where a fabric or woven material is included with the composite at the surface, which is later peeled away, leaving a roughened surface. Wear resistance may be increased by increasing the amount of plastic placed at the surface of the BRC. Preferably the coating does not affect the ability of the member to coil.

The bistable member is constructed so as to resist bending moments and torsion along its length without buckling. Thus, the fibres in the laminate may be aligned with increased amounts of fibres more highly angled to the longitudinal direction of the member. In other words, the composite may have plural layers of fibre angled to the longitudinal direction at between +25 and +65 degrees to the longitudinal direction and at between −25 and −65 degrees to the longitudinal direction. For instance, there may be 2 layers at +45 degrees and 2 layers at −45 degrees, etc. There may further be at least one layer of fibres angled at 90 degrees to give strength in the hoop direction.

The handle may have a coiling diameter that is at least twice that of its diameter in extended tubular form to aid forming the coil around the housing. This has advantages in terms of the packing format, allowing one or more tool heads to be stored at least partly within the space within the inner coil, but also in terms of the cycle life of the product. In particular, a larger rolled diameter generally equates to less stress in the member and therefore is able to tolerate more cycles of coiling/uncoiling yielding a longer life span. The members may be engineered to provide such a diameter by aligning the fibres in the fibre reinforced composite and/or increasing the bending stiffness of the member in the longitudinal direction relative to the transverse direction to achieve a desired, relatively large, coiled diameter. For instance, the angled fibres are angled (or have an average angle if not straight) at between 25 and 40 degrees to the longitudinal axis to increase the Poisson's ratio of these layers in the longitudinal direction (which may also have the effect of increasing longitudinal bending stiffness) so these layers achieve a large coil diameter, in contrast with typical members which do not have this coiling property where the angles used are typically about 45 degrees. Thus, an example layup may be +−30, 90, 0, +−30.

In a second aspect of the present invention, there is provided a method of deploying a tool, comprising uncoiling a bistable reelable composite member from a stable coiled form to a stable elongate slit tube form in which form the member is resiliently biased;
connecting a tool head to an end of the elongate slit tube; and
using the tool with the slit tube serving as a handle by which a use may manipulate the tool head.

The method may comprise stowing the tool after use by disconnecting the tool head from the slit tube member;
opening the member at the slit to a flat form at an end of the member and progressively coiling the member to assume a compact form.

The member may be coiled around a housing, and storing the tool further comprises receiving at least part of the tool head in a cavity defined in the housing in the centre of the coil.

The method may comprise changing the tool head for another, different tool head.

The method may comprise operating a latch in the socket of the tool head to allow the handle to be removed from the socket. In an embodiment, the socket has a protruding element is resiliently biased in the engaging position by a biasing element. Thus, there is less chance of the protruding element accidentally moving to the non-engaging position.

In an embodiment, the protruding element has a ramped camming surface facing the socket opening, such that the leading edge of the handle entering the socket bears on the ramped camming surface and moves the protruding element out of the way whilst the handle is fully inserted into the socket. Preferably the protruding element returns with an audible click when engaging. Thus, the user can simply push the handle into the socket, without having to operate the latch manually. The opposed surface of the protruding element is not ramped, so it butts up against the hole and prevents the handle being withdrawn. Similarly, the element prevents twisting of the handle in the socket.

It will be appreciated that any features expressed herein as being provided “in one example” or “in an embodiment” or as being “preferable” may be provided in combination with any one or more other such features together with any one or more of the aspects of the present invention. In particular, the extendible member, joining techniques and join testing system described in relation to one aspect may generally be applicable to the others.

### BRIEF DESCRIPTION OF THE DRAWINGS

Embodiments of the present invention will now be described by way of example with reference to the accompanying drawings, in which:

FIG. 1 shows an example of a bistable reelable composite;

FIG. 2 shows a perspective view of an example of a kit for providing a tool in accordance with an embodiment of the present invention;

FIG. 3 shows the kit assembled into a form for use;

FIG. 4 shows a sectional view of the tool head attaching to the handle;

FIG. 5 shows the kit disassembled and configured into a form for storage.

### DETAILED DESCRIPTION

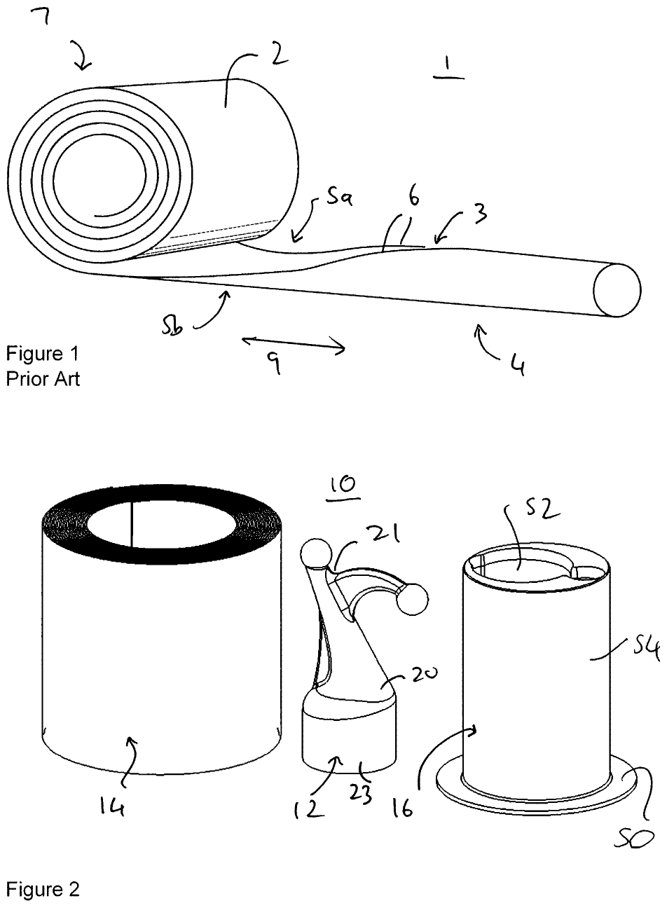

FIG. 1 shows an example of an extendible member 1. The member 1 comprises a fibre-reinforced composite body 2 having a first form in the shape of an elongate slit tube in which shape it is resiliently biased. The slit tube can be opened out at the longitudinal slit 3 defined by the longitudinal edges 6 of the tube so as to be substantially flat so that it can be coiled about an axis transverse to the longitudinal axis of the tube.

The member 1 is bistable, having a first stable form in the slit tube extended form 4 (in which it has a first curvature), and a second stable form when coiled into a coiled form 7 (in which it has a second curvature). Examples of bistable coilable members are disclosed in the Applicant's U.S. Pat. No. 6,217,975 the entire contents of which are hereby incorporated by reference. The member may be constructed with edges as described in the Applicant's U.S. patent application Ser. No. 16/488,116 filed 22 Feb. 2018, the entire contents of which are hereby incorporated by reference, to increase performance of the members. Conventional methods can be used to make the composite or bistable member. Advantageous mechanised production methods of making a composite member are disclosed in the Applicant's U.S. Ser. No. 10/124,545B2 the entire contents are hereby incorporated by reference. Using a bistable member in this way means that the coiled sleeve is stable, meaning that it is easier to handle and store, etc.

In general, the member 1 is manufactured as a fibre-reinforced composite in which various plies of woven, braided or angled fibres 8 (shown in part in FIG. 1) are laid up in a mould or former and heat and/or pressure applied to melt the thermoplastic matrix material consolidate the layers into a composite product. To achieve bistability, at least two plies positioned in the layup towards the intrados 5a and/or extrados 5b faces of the tubular member (i.e. away from the neutral axis of bending of the member), are angled with respect to the longitudinal axis 9 of the product to as to create non-isotropic layers with a high Poisson's ratio. In known examples, a layup of plies with angles of +45, −45, 0, +45, −45 may be used. However, as discussed below, the composite construction may be adapted for specific use as a handle for tools.

Thus, opening out the first curvature of the tube 4 gives rise to tension in the fibres 8 near the intrados face 5a which due to their angle has a component in the longitudinal direction which tends to cause a contraction in this layer in the longitudinal direction. As the tube is opened out to a flatter form, its bending stiffness in a transverse decreases. Once the component of the tension arising in the fibres in the longitudinal is sufficient to overcome the bending stiffness it flips the member into having a secondary curvature in the longitudinal direction, i.e. acting to coil the member, and the tension in those fibres is relieved by that layer contracting. A similar effect is produced by the fibres at the extrados face compressing as the tube is opened out, giving rise to a force component in the longitudinal direction in that layer that tends to cause extension in this layer in the longitudinal direction, which again promotes coiling. Thus, due to the orientation of the fibres, as a portion of the slit tube is opened out, it “flips” into a stable coiled form which relieves partially or fully the strains in the fibres and is thus stable. The member is thus reversibly configurable between a stable coiled form and a stable tubular form by progressively flattening and coiling from one end to coil the member, and extending the member from the coil to assume the tubular form.

FIGS. 2 to 4 show various views of a tool 10, in this example being in the form of a boat hook. FIG. 2 shows the individual components separately, before assembly into the tool in a form for use, comprising a tool head 12, a handle 14 and a housing 16.

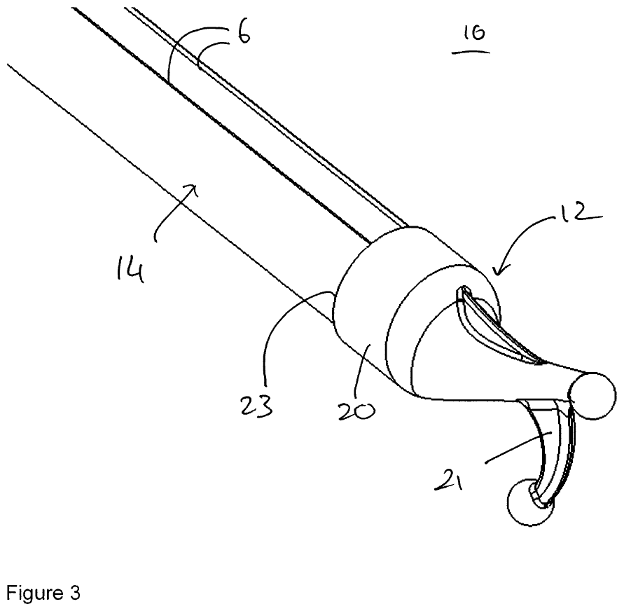

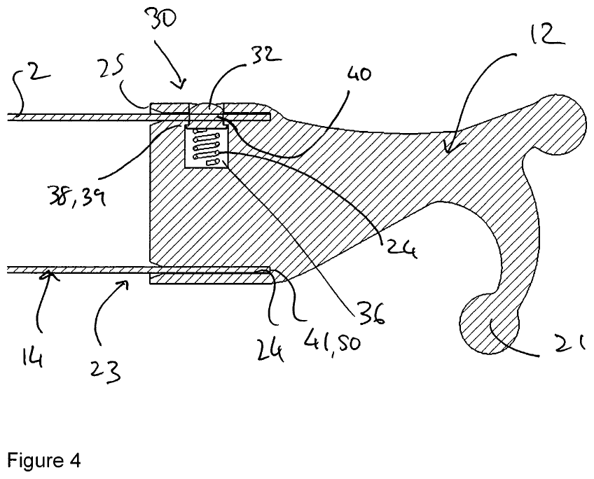

The handle 14 comprises a bistable reelable composite member 1, such described above in relation to FIG. 1. As shown, the member 1 is in its coiled form. The tool head 12 includes a body 20 that has a hook portion 21 for docking, undocking, pulling up lines etc. It will be appreciated that in other examples of tools, the tool head 12 will not necessarily be a hook but will instead comprise a portion adapted for the particular task in hand. The body 20 also has a socket 23 into which fits the distal end of the handle 14 in extended form when the tool 10 is assembled for use, for example as shown in FIG. 3. In some embodiments, the housing 16 may also have a socket (not shown) which allows it to accept the proximal end of the handle 14 so the housing 16 can stabilise the end of the handle and keep the housing attached to the rest of the tool so as to keep it from getting lost while the tool 10 is used. However, in other examples, as described below, the main purpose of the housing 16 is to help the tool 10 stow in a compact form. Thus, the housing 16 has a cavity 52 in which the tool head 12 may be stored when not in use, and about which the handle 14 may be wound when it is in its coiled form.

Referring again to FIG. 3, the member 1 forming the handle is generally curved in cross section (for example circular) and preferably subtends an angle of close to 360 degrees, i.e. nearly forms a complete tube, to provide strength and stiffness to the handle and to aid fitting into a socket. The sockets may have a slightly smaller inner diameter than the natural diameter of the tube such that a user must slightly compress the ends of the tube to fit the member into the socket. The resilient bias of the extended member means that friction helps retain the member in the socket. A small slit may be left for this purpose, such that the angle subtended is between 325 and 355 degrees. However, other angles are possible, including where there is an overlap of the edges, and it is anticipated that angles of anywhere between 270 degrees to 390 degrees may be used for the members.

As shown by the cross section of FIG. 4, additionally or alternatively, the tool head body 20 has a latch member 30 to help retain the handle 14 in position in the socket 23. The socket 23 comprises a slot 24 in the body 20 of the tool head 12, which accepts the end of the handle 14. The handle 14 has a hole 40 near its end which lines up with a protrusion 32 on the latch 30 when the handle 14 is introduced into the socket 23. The latch 30 is operable to move the protrusion into and out of engagement with the hole to respectively secure and release the handle in the socket.

In the present example, the latch 30 is in the form of a button that translates within a cavity 36 in the body 20 against the biasing force of a spring 24 in the cavity. The cavity is open to the side of the tool head and has a neck portion 38, such that a flange 39 around the base of the button bears against the neck and limits movement of the button element out of the cavity. In its most outward position, i.e. its locking position as shown in FIG. 4, the protrusion 32 part of the button extends through the slot 24 forming the socket 23 so as to extend through the hole 40 in the handle when inserted in the socket, and the end of the button presents itself at the opening of the cavity, either flush with or slightly proud of the tool head surface. In this position, the user can depress the button into the cavity against the bias of the spring to move the latch to the not engaging position in which the protrusion 32 is clear of the hole 40 in the handle and allows the handle be withdrawn from the socket. Releasing pressure on the button element returns it to the engaging position by way of the spring force.

In other examples, the latch 30 may operating on a sliding or pivoting principle to move the protrusion into and out of the hole in the handle. If required, more than one latch may be provided, or more than one protrusion and hole may be provided operated by a single latch. Multiple engagement points may help secure the handle in the socket, if for example the tool head is expected to under go significant twisting or tensile forces.

In some examples, the protrusion 32 may be shaped with a ramped camming surface (not shown) facing the socket 23 entrance arranged such that the leading end 41 of the handle 14 being introduced into the socket bears on the ramped surface and automatically moves the latch to the non-engaging position allowing the leg member 14 to be simply pushed into the socket without manually operating the latch 30. Once the member is fully introduced into the socket 23, such that the leading end 41 butts against the end of the slot 50 in the socket 23, the protrusion 42 enters the hole 40. The protrusion 42 has a non-ramped surface facing away from the socket 23, i.e. the side wall of the protrusion 42 is generally perpendicular to the direction of the relative motion of the handle being inserted/removed to/from the socket such that it latches against the side of the hole 40 and prevents the leg from being withdrawn. Similarly the protrusion 42 may have a non-ramped surface preventing the handle from being twisted in the socket.

When inserting the handle 14, it may be necessary for the user to rotate the handle 14 in the socket 23 (where the sockets and handle are circular in cross section) to rotationally align the protrusion 32 with the hole 40 before it engages. Alternatively, the inside of the socket may have guides (not shown) arranged to register with the edges of the slit tube member to rotationally align the member as it is inserted into the socket to align the holes with the protrusions. Alternatively, non-circular sockets and legs could be used which do not permit arbitrary rotational alignment. The entrance to the socket may have tapered surfaces 25 to aid inserting the end of the handle.

Nonetheless, other ways of attaching the handle to the tool head may be used, for example a clamping collar that clamps the handle against the periphery of the tool head, etc.

Preferably the tool head 12 and housing 16 are made at least partially from moulded plastics material to keep down weight and cost and for ease of manufacturing, optionally with metal inserts for strength or to provide the working portion of the tool head where additional strength or hardness is required.

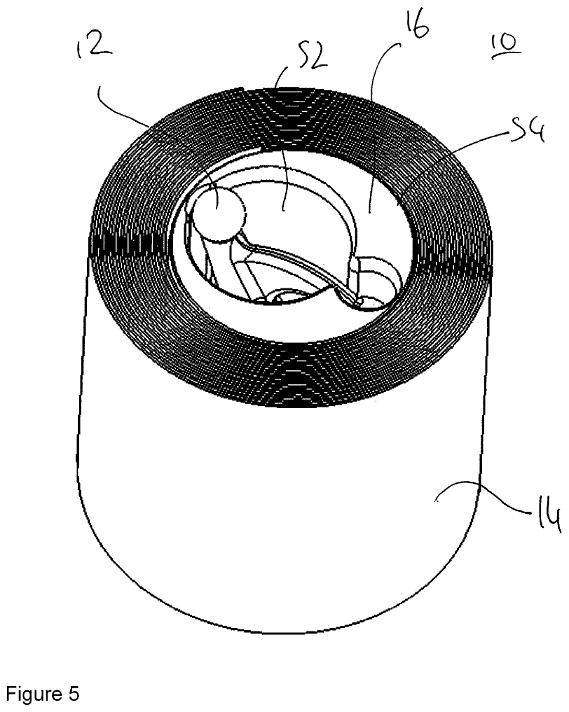

Thus, a tool 10 is provided that can be collapsed to a form suitable for being stowed, as shown by FIG. 5. First the handle 14 is disengaged from the socket 23 in the tool head 12, i.e. by depressing the latch and pulling the handle free. In examples where the housing is inserted to the opposite end of the handle, the housing is also pulled free. The handle 14 is then flattened at one end and coiled around the external periphery 54 of the housing 16. As shown in FIG. 1, the housing 16 has a flange 50 to help align the member as it coils around it. The tool head 12 is then inserted into the cavity 52 in the housing, such that it is at least partially received in the space in the middle of the coils. The tool head 12 may be a friction fit in the cavity 52 or some form of latching or bayonet fixing or strap arrangement may be used to hold it in place. Thus, the assembly forms a unitary and compact form which allows storage and transport without risk of parts being lost or damaged. In this collapsed form, the disassembled kit can be stowed in a bag or box, etc. It will be appreciated that certain steps in the process can be performed in a different order, e.g. the tool head can be inserted into the housing before the handle is coiled around the periphery of the housing.

The coiling diameter of the handle is chosen to match the external diameter 54 of the housing. Preferably the coils have a slightly smaller internal diameter so as to “hug” the external periphery 54 to keep it in place.

The tool is assembled by following the steps in the reverse order.

Such members 1 are typically manufactured on tubular formers or (in a continuous manufacturing process) in tubular dies in the extended tubular form to achieve an extended member of the desired cross section. The diameter of the member in its coiled form can be controlled by carefully selected orientation and positioning of the layers of fibre.

The bistable member 1 forming the handle 14 is typically between 1 m and 2 m in length and between 25 mm and 50 mm in deployed tube diameter.

The coiled inner diameter is specifically designed to give the most compact size. Nonetheless, it will be appreciated that in practice there is a minimum diameter practicably achievable, which typically would be between 50 mm and 100 mm. This internal space of rolled BRC is preferably utilised for compact storage of heads. These may be provided in a housing, which holds the head and provides a regular surface for the coil to form around. Alternatively, the member may coil directly around the tool head, particularly where this has a regular diameter portion that naturally provides a suitable surface to promote coil formation. Where a housing is used, the housing may accommodate plural tool heads. Thus, where the coil inner diameter is relatively large, more than one tool head may be held by the housing at least partly within inside the space within the coil. Alternatively, the tool heads may be held without the space in the coil by a first portion of the housing, with a second portion of the housing providing a form for the coil.

The bistable member construction is optimised to create required stiffness in torsion and bending for the application, while remaining easy to roll and deploy. A combination of optimised BRC construction and mechanically locking the end of the BRC into a socket arranged as described above so that it locks together the opposed edges of the BRC so no relative movement is possible at this position helps prevent the overall handle from twisting.

In most applications, it is anticipated that the member 1 will have a larger coiling diameter than its extended tubular diameter, for instance between 2 and 4 times larger. The larger coiling diameter may be achieved by increasing the longitudinal bending stiffness of the member 1 or changing the angles of the fibres relative to the longitudinal axis. For instance, additional longitudinal plies may be included to increase the bending stiffness, and/or the angled plies may be orientated to be angled less close to the longitudinal axis to achieve a greater coil diameter without sacrificing bistability. For instance, the angled fibres are angled (or have an average angle if not straight) at between 20 and 40 degrees to the longitudinal axis to increase the Poisson's ratio of these layers in the longitudinal direction so these layers achieve a large coil diameter, in contrast with typical members where the angles used are typically about 45 degrees. Thus, an example layup may be +−30, 90, 0, +−30.

The BRC construction may be optimised to give wear resistant surface and or a high friction surface to aid user grip. For instance, the outer surface may be coated in textured rubber or the like, or an abraded or textured surface.

The bistable member 1,14 construction may be reinforced at the end received in the socket of the tool head and or around the hole with which the latch engages. For instance, a rubber sheet may be bonded across the edge to help prevent delamination as these areas are exposed to higher wear as they are inserted into/out of the socket.

Thus, a combination of these various adaptations of the BRC may be used to make it particularly suited to the present application, so that the BRC can withstand multiple cycles of deployment and use, without failure.

The tool may be provided with plural interchangeable heads. For instance, a tool with a set of interchangeable tool heads may be provided for:
household indoor use, providing functions including any of: mops, soft brooms, dusters, window cleaners, paint brush or roller holder, loft hatch opener, bulb changing, roof light opener, any other long-handled internal cleaning tools and high-reach applications.
household outdoor use, providing functions including any of: brooms, rakes, hoes, lopper/pruner, fruit picker, window cleaning and other long-handled external cleaning tools, litter picker.
marine use, providing functions including any of boat hook, swabbing brush, soft broom.

Embodiments of the present invention have been described with particular reference to the example illustrated. However, it will be appreciated that variations and modifications may be made to the examples described within the scope of the present invention.

1. A tool comprising:
a tool head; and
a handle, wherein an end of the handle is connectable to the tool head, wherein the handle comprises a bistable reelable composite member having a first stable form in the form of an elongate slit tube in which form the bistable reelable composite member is resiliently biased and acts as a handle when connected to the tool head, and wherein when separated from the tool head, the elongate slit tube can be opened out at a slit at an end and progressively coiled around an axis transverse to its length to reversibly attain a second stable form in the form of a coil.

2. The tool of claim 1, wherein the tool head has a socket for receiving the end of the bistable reelable composite member.

3. The tool of claim 2, wherein the end of the bistable reelable composite member positively locks in the socket.

4. The tool of claim 3, wherein the socket has walls that support inner and outer surfaces of the bistable reelable composite member received in the socket and locks edges of the bistable reelable composite member to prevent movement relative to each other in order to stabilise the bistable reelable composite member.

5. The tool of claim 4, wherein the walls of the socket have engagement features that guide the bistable reelable composite member into a locking position in the socket.

6. The tool of claim 5, wherein the socket has one or more latches for engaging with a corresponding feature in the end of the bistable reelable composite member to prevent the bistable reelable composite member being removed from the socket.

7. The tool of claim 6, wherein the latch is movable by a user of the tool against a resiliently bias from an engagement position in which it engages with the corresponding feature in the end of the bistable reelable composite member to a release position in which the bistable reelable composite member can be released from socket.

8. The tool of claim 6, wherein the latch engages with a hole through the end of the bistable reelable composite member.

9. The tool of claim 8, wherein one of the hole and an end of the bistable reelable composite member is one of reinforced and treated to avoid delamination.

10. The tool of claim 1, comprising plural different tool heads which can interchangeably be connected to the bistable reelable composite member.

11. The tool of claim 1, comprising a housing, the housing having an outer diameter adapted so that the bistable reelable composite member can coil around it.

12. The tool of claim 11, wherein the housing is adapted to couple to one or more tool heads with the bistable reelable composite member coiled round it.

13. The tool of claim 1, wherein the bistable reelable composite member has a surface adapted for one of gripping by a user and wear resistance.

14. The tool of claim 1, wherein the bistable reelable composite member is constructed so as to resist bending moments and torsion along its length without buckling.

15. A method of deploying a tool, comprising uncoiling a bistable reelable composite member from a stable coiled form to a stable elongate slit tube form in which form the bistable reelable composite member is resiliently biased, the method comprising:
connecting a tool head to an end of the stable elongate slit tube; and
using the tool with the stable elongate slit tube serving as a handle by which a use may manipulate the tool head.

16. The method of claim 15, further comprising stowing the tool after use by:
disconnecting the tool head from the stable elongate slit tube;
opening the bistable reelable composite member at a slit to a flat form at an end of the bistable reelable composite member; and
progressively coiling the bistable reelable composite member to assume a compact form.

17. The method of claim 16, wherein the bistable reelable composite member is coiled around a housing, and storing the tool further comprises receiving at least part of the tool head in a cavity defined in the housing in the center of the coil.

18. The method of claim 15, comprising changing the tool head for another, different tool head.
